(19) United States
(12) Patent Application Publication
(10) Pub. No.: US 2020/0410616 A1
(43) Pub. Date: Dec. 31, 2020

(54) METHOD AND SYSTEM FOR VIDEO CONTRACTS

(71) Applicant: Lexigogo BVBA, Peer (BE)

(72) Inventor: Laurens Theunis, Brussels (BE)

(73) Assignee: Lexigogo BVBA, Peer (BE)

(21) Appl. No.: 16/969,196

(22) PCT Filed: Jul. 6, 2018
(86) PCT No.: PCT/EP2018/068416

§ 371 Date: Aug. 12, 2020

(30) Foreign Application Priority Data
Feb. 14, 2018 (EP) 18156762.9

(51) Int. Cl. G06Q 50/18; H04N 5/77; H04N 5/265; G06K 9/00; G11B 27/036; G06Q 30/00; G06Q 10/10; G06Q 20/12; G06Q 20/36; G06Q 20/38; G06Q 20/40; G06F 21/64; H04L 9/32; H04L 9/06

(52) U.S. Cl. CPC G06Q 50/18; H04L 2209/38; H04N 5/265; G06K 9/00288; G11B 27/036; G06Q 30/0185; G06Q 10/10; G06Q 20/1235; G06Q 20/3674; G06Q 20/3825; G06Q 20/401; G06F 21/64; H04L 9/3213; H04L 9/0637; H04L 9/0643; G06Q 2220/00; H04N 5/77

(57) ABSTRACT

The current invention provides a method for electronically signing a video contract between a first user having a first device and a second user having a second device based on a portion of video content; said second user being different from said first user; said portion of video content providing information relating to said video contract; said first device comprising a camera for recording video, a screen and connection means; said second device comprising a screen and connection means; the method comprising a plurality of steps. The invention further provides a system, use, a computer program product and a video contract.

### TECHNICAL FIELD

The invention pertains to the technical field of video contracts in a data network context.

### BACKGROUND

Written contracts are a common basis for agreements between parties, yet lack intuitiveness. Even in a completely electronic workflow, where both the contract composition and the signing are done electronically, such traditional contracts suffer the drawback of lacking intuitiveness, requiring too complex writing or reading skills, and overall leading to a slow and inflexible way of making agreements between parties. In practice, many people resort to purely verbal agreements. In fact, most agreements people make in daily life are verbal, and only for a few critical agreements a written contract is considered. Reasons for working without written contract may include any or any combination of the following:
Agreement is considered not to be significant enough to write down.
Both parties trust one another.
Don't want to get lawyers involved as too expense and time-consuming, and as it automatically creates a two-sided situation.
No pen and paper available.
Not able to write or read.

This said, not having a written contract may have important risks and consequences, which may include any or any of the following:
No proof available to demonstrate rights and obligations of the parties.
Agreement may be subject to different interpretations afterwards.
Frustrations and lack of trust may end future interactions between parties.

Furthermore, written contracts may be problematic in view of functional illiteracy, referring to a large group of people worldwide who are able to read and write simple sentences but are not able to deal with longer and complex texts. Functional illiteracy causes large problems in daily life, related to e.g. opening of bank accounts, reading ingredients of food products, understanding medication or technical instructions and also to the signing of contracts.

US 2017/0140486 discloses a related method but is inadequate to address the problem of functional illiteracy.

US 2012/0323796 discloses a related method, but suffers all the drawbacks of written agreements.

The present invention aims to resolve at least some of the problems mentioned above.

### SUMMARY OF THE INVENTION

In times of massive smartphone usage, video contracts are a promising alternative to traditional written contracts.

In a first aspect, the present invention provides a method according to claim 1.

Hereby, the invention advantageously combines the use of a first device for said recording, said composing and said signing by the first user, on the one hand, with the use a second device useful at least for determining a link between the second user as identified in the video contract and the actual person signing the video contract, leading to a reliable and user-friendly solution to a range of problems, one of such problems being of how to electronically sign a video contract in a reliable and user-friendly way by means of basic electronic devices such as smart phones. Crucially, the invention may but does not require the second user to actually view the video on the second device, since the video may be viewed on the first device, or viewing may be altogether avoided, since, according to a preferred embodiment, the second user is present while the portion of video content is being recorded. As such, the invention offers a solution that may reduce the second device to a mere means of identification, leading to a faster, simpler and more flexible method than prior art methods for handling video contracts. In a preferred embodiment, each of the users signing the contract are provided with easy and ensured access to the video contract as available on the server.

In a second aspect, the present invention provides a system according to claim 25.

In a further aspect, the present invention provides a use according to claim 26, a computer program product according to claim 27 and a video contract according to claim 28.

Preferred embodiments and their advantages are discussed in the detailed descriptions and the dependent claims.

### DESCRIPTION OF FIGURES

FIG. 1 shows an example embodiment of the method of the present invention.

FIG. 2 shows an example embodiment relating to smart video contracts.

FIGS. 3a-3b show a flow diagram of an example method for creation of a video contract.

FIG. 4 shows a flow diagram relating to states of an example video contract according to the present invention.

FIG. 5 shows a flow diagram relating to states of an example user account.

FIG. 6 shows an example software as a service architecture.

FIG. 7 shows an example workflow relating to a set-up with third-party application integration.

FIGS. 8a-8e show example information flows relating to the invention.

### DETAILED DESCRIPTION OF THE INVENTION

As stated in the Summary section, written agreements lack intuitiveness and may be problematic in view of functional illiteracy. On the other hand, not having a contract may have important risks and consequences. Video contracts offer a viable alternative to both traditional written agreements and verbal agreements, with for example following advantages:
Fast, simple and flexible.
Easy and ensured access to proof.
No complex writing or reading skills required.
Video is a legally binding transcript in many countries. In some countries, certain agreements do require a written contract, e.g. sale of real estate.

Moreover, video contracts provide a viable alternative to written agreements in case of functional illiteracy, referring to a large group of people worldwide who are able to read and write simple sentences but are not able to deal with longer and complex texts. In a preferred embodiment, the present invention is adapted to overcome any problem relating to functional illiteracy, e.g. by avoiding the use of sentences in its interface to users and/or by including in its interface to users only sentences of length less than e.g. twenty words, more preferably less than ten words.

Typical applications of video contracts envisaged by the present invention include following B2C and/or B2B example use cases.
B2C and/or B2B, preferably between personal user accounts: record damage after accident, sale and rent of small goods and services, purchase options, lending and borrowing, family agreements, royalty/licensing agreements amongst musicians, secrecy agreements, etc.
B2C and/or B2B, preferably between company profiles and personal user accounts: car repair agreements, small home construction projects, web development, tailoring, venue rental, catering services, etc.
B2C and/or B2B, preferably between company profiles: integrated approach where larger corporations can have a (custom-made) business account, which is accessible to their clients who have a personal user account, with examples of use cases including the following: car-rental and car-sharing services, insurance services, notary services, governmental services.

In a preferred embodiment, a company profile is part of a personal user account. In other words, in the context of the present invention, a user account is preferably personal and is preferably a top hierarchy element identifying a user, whereby a company profile is preferably defined as belonging to at least one user account that is preferably personal.

In a preferred embodiment, the number of users jointly signing the video contract, i.e. the number of users including the first user, the second user and any further users, is equal to two, three, four, five, six and/or is larger than one, is larger than two, is larger than three, is larger than four, is larger than ten, is larger than fifty, is larger than hundred.

In a preferred embodiment, at least one of the first and second user and any optional further users carries out at least one step relating to the present invention by means of a mobile application or “app” (hereafter app), a desktop “PC” application or a web interface accessible via the internet, i.e. different embodiments of a computer program product according to the present invention. In a more preferred embodiment, at least the first user carries out at least the steps of composing the video contract and uploading the video contract by means of said app, whereby his user account provides him with access to one or more uploaded video contracts, preferably all video contracts that are currently valid and in which the user is party to the video contract.

In one embodiment, whereby the user has access to one or more uploaded video contracts present on the server, the method may comprise the additional step of allowing one of the users, preferably all of the users, to terminate the video contract. In a preferred embodiment, a graphical user interface for display on said first and/or second device is provided for accessing said one or more uploaded video contracts, and the graphical user interface comprises, for at least one uploaded video contract, means for sending a termination request to (the devices of) the other users involved. Such a termination request preferably is sent to the server and subsequently forwarded to each of the other users involved. Upon receipt, each of the users receiving the termination request are preferably prompted to take action based on a notification on their device. Hereby, the video contract may be terminated successfully if some given percentage, e.g. at least 66% or at least 100% of the users, agrees to terminate said video contract. A terminated video contract may preferably remain available on the server while preferably comprising an indication that said video contract is terminated. In an alternative embodiment, said terminated video contract is deleted from said server after termination has been completed, e.g. immediately after termination is completed, or after some fixed number of days, e.g. 7 or 14 days, or months, e.g. 1 or 2 months, or years, e.g. 1 year, 2 years or 5 years.

Furthermore, the invention relates to a digital service wherein a digital video recording serves as agreement or contract between two or more parties, i.e. two or more users. Particularly, the invention provides a method for composing and signing a video contract between two or more parties. The digital video recording, i.e. the portion of video contents, is preferably made by means of the mobile device of one of the two or more parties, i.e. the first party. This is preferably done by means of an app relating to the service, or, alternatively, by means of a third-party app which is in connection with a third-party server different from said server. For each party, the portion of video content preferably contains at least one sub-portion in which the party describes the contract, whereby preferably at least the face of the party is visible. After the recording, or, alternatively, the receipt of the portion of video content at the first device, the portion of video content is uploaded to a server by means of said mobile device of said first party. Preferably, from this point onward, the portion of video content is part of a video contract that is to be confirmed and that is stored centrally, rather than being stored on the device of one of the parties. In a next step, preferably the video contract is presented for signing to at least one of the parties and preferably to each of the parties on their respective device by means of a video contract signing invitation which is sent preferably via some authenticated channel, preferably by means of the app running at least on the first device and preferably on each of the devices, alternatively on the first device by means of the app running on the first device and/or on the second device by means of some messaging service including e-mail, sms or a smartphone messaging app. Upon signing by all parties, preferably explicit signing by all parties, the video contract is signed and may be effective.

In a preferred embodiment, said step of said providing of said video content comprises recording, by said first user, said portion of video content by means of said first device, preferably wherein said providing of said video content consists of recording, by said first user, said portion of video content by means of said first device. Such an embodiment may relate, e.g., to an embodiment wherein the first user records the portion of video content by means of said first device by means of any video recording app, to then “import” the portion of the video content by providing it the first step according to the present invention. This contrasts with an embodiment equally pertaining to the invention, wherein the first user uses a further device, e.g., a digital camera, to record the portion of video content, to transfer it to the first device only later on with the aim of composing a video contract based on said portion of video content. In a further preferred embodiment, the recording of the portion of video content is also performed by means of said first device. This provides the advantage of enhanced user-friendliness.

In another preferred embodiment, said uploading takes place at least partly during any of said step of providing said portion of video content and said step of said composing, preferably at least partly during said step of composing. This has the advantage that the potentially time-consuming process of uploading the video content is initiated before the user provides the details of the video contract. This maximizes the time between the start of the upload and the time at which the user has finished composing the video contract. This may be beneficial for the user who, after finishing the composing of the video contract, may experience a reduced waiting time or even no waiting time until completion of the upload.

In a preferred embodiment, the portion of video content may also be recorded, preferably by means of the app, when the first device is not connected to said server, yet whereby the location stamp is still being recorded. This enhances user friendliness without compromising too much on the reliability of the information, whereby the presence of the location stamp “compensates” for the delayed uploading of the portion of video content to the server.

In this document, the terms “GNNS” refers to a global navigation satellite system, such as the Global Positioning System (GPS), GLONASS, Galileo and BeiDou or BeiDou-2. In a preferred embodiment, the first device has access to coordinates determined by a positioning module, whereby said positioning module may or may not be comprised in said first device. The positioning performed by said positioning module may relate to any or any of the following: GNNS positioning, WiFi-based positioning, Bluetooth-based positioning, and cellular-network-based positioning. Furthermore, the terms “user” and “party” are used interchangeably in this document. Likewise, the terms “agreement” and “contract” are used interchangeably.

In this document, the term “REST” refers to representational state transfer technology. An API is said to be RESTful if it is based on REST. In one embodiment, this relates to an API that relies on HTTP requests such as GET, PUT, POST and DELETE to preform communication. In a preferred embodiment, the API mentioned in this document is RESTful; in an alternative embodiment, it may be SOAP-based, where SOAP stands for Simple Object Access Protocol. The term SDK refers to Software Development Toolkit. In preferred embodiment, integration of the invention with respect to the third-party application is realized by means of an SDK, said SDK preferably comprising said API-related interface.

In this document, the terms “server” and “cloud” are used interchangeably, both terms referred to backend infrastructure present in the network to store video contracts and preferably to support the composition and signing of video contracts.

In this document, the term “blockchain” refers to a distributed database keeping a continuously growing list of registrations in blocks, which are specified incontestably, are kept up to date and cannot be adapted. Hereby, it is immaterial which variant of blockchain is intended, and all distributed ledger technology (DLT) may serve as blockchain. Moreover, in a preferred method, the present invention is agnostic with respect to the specific blockchain used, and may be applied to any of a wide range of blockchain types without requiring alteration. In a preferred embodiment, the use of multiple blockchain types is possible concurrently, with e.g. a system that has access to multiple blockchains and registers a portion of data in blockchain A for user A while registering a second portion of data in blockchain B for user B. Related, the term “blockchain” and “distributed ledger technology” are used interchangeably in this document. This includes all common types of blockchains and related ledgers known to the skilled person. Hereby, it may concern a permissionless or permissioned blockchain, a public blockchain such as the bitcoin blockchain or the Ethereum blockchain, a private blockchain, a blockchain with centralized, decentralized, or distributed ledger control. The consensus mechanism involved in the adding of data to the blockchain preferably concerns distributed consensus. This may involve proof-of-work but may also and/or alternatively involve any of the following: proof-of-stake, a leader-based system, a voting-based system or a principle based on hashgraph. In a further preferred embodiment, the term “blockchain” refers to a blockchain-based distributed computing platform supporting smart contract functionality such as Ethereum, wherein one or more users preferably have access to an electronic wallet available on said blockchain-based distributed computing platform, said electronic wallet preferably comprising one or more cryptocurrencies. In this document, each of the first and second device is preferably a smartphone, an optical display, preferably a head-mounted optical display, a tablet, a laptop computer, a smartwatch or a desktop computer. In one embodiment, both the first device and the second device are smartphones. In another embodiment, the first device is a tablet and the second device is a smartphone. In yet another embodiment, the first device is a smartphone and the second device is a mobile phone without smartphone capabilities or a smartphone of which the cellular data capabilities are currently unavailable, e.g. because cellular data is turned off in view of roaming costs.

In this document, the term “user account” refers to a personal set of protected data stored on said server for providing a user with access to one or more uploaded video contracts and/or further services related to video contracts. The account is preferably accessed by means of an app on the device of the user. Identification of said account may be possible by means of a user name and/or an e-mail address. Authentication with respect to said account, preferably performed via said app, may be based on a password. In a preferred embodiment, an app is authenticated with respect to a user account on first use and subsequently is protected by means of a pin code, e.g. a four, five or six digit numeric code. In a related embodiment, access to the account and/or the app may be additionally and/or alternatively restricted by means of biometric authentication, e.g. fingerprint recognition or face recognition.

The connection means of the first and second device preferably relate to cellular voice and/or data communication such as 2G, 3G, 4G or 5G networks and/or to access to a WiFi network which preferably complies with an IEEE 802.11 standard such as IEEE 802.11n or IEEE 802.11ac. Furthermore, the connection means may relate to a Bluetooth connection. In one embodiment, both the first device and the second device comprise means for cellular data connection, with 3G or higher. In another embodiment, the first device comprises means for cellular data connection but the second device only means for cellular voice communication and limited data functionality relating to e.g. SMS, as is the case for a mobile phone without smartphone functionality.

As the invention provides several aspects that are closely related, the skilled person may easily see that all embodiments given in this document may relate to any aspect of the present invention. For instance, the method and the system relate in that the system may be configured for executing steps belonging to the method, and the method may be executed on the system.

In a first aspect, the invention provides a method according to claim 1.

Hereby, said first and second electronic signature provide a means for verifying that the persons signing the video contract indeed correspond to said identification of said first user and said second user. In one embodiment, this relates to the use of asymmetric cryptography such as PKI (public key infrastructure), whereby a key pair is associated with one, two and/or all users, preferably all users. The key pair comprises a private key and a public key. Hereby, the private key is known only to the user and may be used to encrypt a byte string, e.g. a message digest, while the public key may be publicly available and may be used to decrypt said encrypted byte string. In such an embodiment, the identification of the user may be bound to the public key belonging to said key pair, whereby e.g. said identification comprises said public key or at least comprises some reference allowing to retrieve the public key of said user. Hereby, the user may sign the video contract by applying his private key to the video contract, e.g. by encrypting the message digest associated with the video contract by means of said private key, yielding at least one of said first and second electronic signature. Verification of said electronic signature may than be done by any party by decrypting said electronic signature by means of said private key. The PKI may involve a Certificate Authority and/or the use of a blockchain, e.g. a blockchain to store the public keys of one or more of the users. In a preferred embodiment, the first and second electronic signature relate to a token or similar code that is generated for the purpose of verification, whereby said token is delivered to a contacting means comprised in the identification of the user. By delivering the token through the contacting means, e.g. an e-mail address or an account of the user on said server, it is verified that the user providing the electronic signature indeed has access to said contacting means. In another preferred embodiment, the electronic signature is generated by both using the contacting means and by letting the user apply its private key.

It is noted that said steps may be executed according to different possible sequences. In one embodiment, said uploading precedes said sending of said video contract signing invitation, whereby the second user, upon receipt of the video contract signing invitation, preferably signs the video contract first, by sending the second electronic signature to the server. The first user may then, e.g. triggered by a notification from the server upon receipt of said second electronic signature, also sign the video contract, by sending said first electronic signature to the server. In another embodiment whereby said uploading precedes said sending of said video contract signing invitation, the second user, upon receipt of the video contract signing invitation, may modify the video contract by modifying the contract specification and/or by editing the portion of video contents, after which the first user may sign the video contract, followed only then by the signing of the second user. In yet another embodiment, said sending of said video contract signing invitation comprises sending a first invitation to said first device and, preferably essentially simultaneously, a second similar invitation to said second device and optionally further similar invitations to further devices if further users are involved. In such an embodiment, the receiving of said first and said second and any optional further electronic signatures takes place essentially asynchronously, the sequence being function of the time it takes for each of the users to respond.

In a preferred embodiment, said identification of said first and said second user relates to a digital user account stored on said server or another server, an e-mail address and/or a phone number. The identification may hence comprise or be any account identification with any online platform, e.g. a mail account, an account on a social networking platform, an account on an auction and/or shopping platform, an electronic wallet preferably relating to a distributed ledger such as Ethereum, an identification on a distributed ledger such as Ethereum. In an alternative embodiment, said identification may relate to user-related information such as a password number, a combination of name and date of birth, a social security number, an address, whereabouts of the user and/or may relate to device-related information such as unique identification of the device, a model type of the device, a version of an operating system on said device, a cookie, whereabouts of the device, current location of the device, evolution of the location of the device over time.

In a preferred embodiment, said sending of said video contract signing invitation to said second device is performed by said server; wherein said sending of said video contract signing invitation preferably takes place after said uploading has been completed. Such an embodiment advantageously provides mediation by the server. In such a set-up, the video contract including the portion of video content need not be stored locally on either of the smartphones and moreover need not be sent in its entirety to the second device, reducing the burden on the electronic devices, which may e.g. be simple smartphones. In a further preferred embodiment, the video contract signing invitation is thereby sent by the server after said uploading has been completed. This has the advantage that, upon receipt of the video contract signing invitation, the second user may find the entire video contract including the portion of video content available for viewing on the server. This may lead to a more user-friendly experience for the second user.

In an alternative embodiment, the video contract signing invitation is sent to the second user already when the uploading of the video contract is still in progress. In one example embodiment, the step of uploading said video contract from said first device may comprise uploading the contract specification first, to then initiate the uploading of the portion of video content, whereby a certain upload progress threshold may trigger the sending of said video contract signing invitation by said server. In one example, the upload progress threshold may relate to a certain relative indicator of the remaining portion of video content yet to be uploaded, e.g. less than 100% or 80%, more preferably less than 50% or less than 40%, most preferably less than 30% or 25% or 20% or 10%. In another embodiment, the upload progress threshold may relate to a certain absolute indicator of the time until complete uploading of the portion of video content, e.g. relating to the amount of bytes yet to be uploaded, such as less than 100 MB or less than 10 MB or less than 1 MB, or relating to the estimated/extrapolated time (in seconds) until upload completion, e.g. less than 60 seconds or less than 30 seconds. Such an embodiment may be advantageous in that it may expedite the video contract signing.

In one embodiment, said sending of said video contract signing invitation to said second device is carried out by said first device, preferably without an intervention of said server, preferably whereby said first and said second device communicate according to a peer-to-peer technology, more preferably a near-distance wireless technology. Such an embodiment is advantageous because it allows users to compose a video contract and preferably sign said video contract without the need for connecting to the server, e.g. in environment where no wireless network is available, and subsequently upload the video contract and/or the electronic signatures as soon as connectivity with the server is restored. Examples of a near-distance wireless technology include Bluetooth, particularly Bluetooth-based Object EXchange (OBEX), infrared communication, e.g. infrared-based OBEX, more preferably Near Field Communication, each avoiding the need for a server in the data exchange and hence corresponding to a peer-to-peer wireless technology. Other peer-to-peer wireless technologies may relate to any type of short-distance or long-distance communication including 3G, 4G, 5G, satellite communication, camera-based exchange of information, cabled communication.

In a preferred embodiment, said second user is present within line-of-sight of the second user at least during the step of composing said video contract and preferably also during the recording of said portion of video and/or during the uploading of said video contract, whereby a distance between said first user and said second user is preferably smaller than 20 m, more preferably smaller than 10 m, most preferably smaller than 2 m. In such an embodiment, the invention advantageously uses the first device for performing most of the steps relating to the invention, which is within line-of-sight of the second user and hence may be presented to the second viewer for watching while the first user composes the video contract and uploads it to the server. Hereby, the invention may but preferably advantageously does not require the second user to actually view the video on the second device, since the video may be viewed on the first device, or viewing may be altogether avoided, since, according to a preferred embodiment, the second user is present while the portion of video content is being recorded. Moreover, this may advantageously allow that the second device is a simple device such as a plain mobile phone without smartphone capabilities, since such a simple device suffices to allow for identification of the second user, and most steps of the method may be handled on the first device which may be more suitable for executing the method steps, e.g. by comprising a large screen.

In a preferred embodiment, said first device comprises means for attributing a location stamp to video content; wherein said step of providing said portion of video content to said first device, preferably by recording, comprises adding said location stamp to said portion of video content; and wherein said video contract comprises a location indication based on said location stamp. Such an embodiment is advantageous in that the second user is informed regarding the place where the video is provided and/or recorded, preferably recorded, and, by extension, regarding the jurisdiction relating to the video contract. In one embodiment, the location indication is simply the location stamp itself. The location stamp may relate to a location as it was measured at the time of recording of the video by some positioning module, preferably a positioning module comprised in the first device, and was subsequently added to the portion of video content by the first device. Alternatively, the location stamp may relate to a location stamp as it was measured at the time of composing the video contract. In one embodiment, the location stamp concerns a set of global coordinates, preferably GPS coordinates. In another embodiment, the positioning is based partially or solely on identifying one or more cellular networks within range, whereby the country to which the identified networks relates may be taken as eventual location stamp. Hereby, it is to be noted that the latter may be less precise than GNNS-based localization, but may still be sufficiently precise in the context of the present invention, where knowledge of the country in which the portion of video content is recorded and/or knowledge of the country in which the video contract was composed may be sufficient to determine a jurisdiction under which the video contract may be assumed to be valid. In a preferred embodiment, the location indication may either be this location stamp, or, for various reasons such as user privacy, may concern a less specific descriptor of the location, such as the region or the country wherein the coordinates are located.

In a preferred embodiment, said first device comprises means for attributing a time stamp to video content, preferably a recording time stamp; wherein said step of recording said portion of video content comprises adding said time stamp to said portion of video content; and wherein said video contract signing invitation comprises at least an indication relating to said upload time date and preferably additionally an indication of a time at which said contract signing invitation is sent. This is advantageous because it may inform the second user of a delay between the time of recording the portion of video content and the actual uploading and/or composing of the video contract. This may allow to detect whether the portion of video content is recorded before or after some known event. This may be important for instance where the video contract relates to the interior decoration of a house, whereby a certain phase of the works has taken place on a certain date, and the video contract may or may assume that said phase has already been completed.

In a preferred embodiment, said identification of at least one of said first and second user comprised executing a face recognition algorithm on said portion of video content and/or of a picture taken with said camera of said first device for improving reliability of said identification. Hereby, said picture taken with said camera of said first device is preferably comprised in said step of composing the video contract. In case of executing said face recognition algorithm at least on said portion of video content, the invention advantageously combines the collecting of the portion of video content with the collecting of the identification of the first and second user. In case of executing said face recognition algorithm at least on said picture taken with said camera of said first device, the invention advantageously “reuses” the camera which is preferably present in the first device for recording video for the aim of identification, which leads to a user-friendly experience for the users being identified.

In a preferred embodiment, said composing of said video contract comprises executing an object recognition algorithm and/or a product recognition algorithm on said portion of video content, wherein an output of said object recognition algorithm and/or said product algorithm is used for editing said portion of video content and/or modifying said contract specification. Hereby, algorithms for object recognition and for product recognition serve related aims, whereby “object” may refer to a generic object, e.g. a package packed in cardboard, and “product” may refer to a specific, typically brand-related object, e.g. a package expedited by company A. In view of the similarity in aim, a single algorithm may serve both the purpose of object recognition and product recognition. However, one skilled in the art may appreciate that these aims may also require different implementations of a single algorithm, or even two or more different algorithms. Outputs of such algorithms may include a category of the object or product, e.g. where the video contract relates to furniture or food, a brand and/or model type of the object or product, e.g. where the video contract relates to a car, or a unique identification of the object or product, where the video contract relates to a car bearing a license plate or an electronic device of which the serial number is visible. In one embodiment, one or more of such outputs may be used to edit said portion of video, e.g. by “printing” information relating to recognized objects or products in a visible zone of the video contents for a certain period of time, e.g. 1 or 2 seconds, for indicating that an object or product has been recognized. In another and related embodiment, one of more of the outputs may additionally/alternatively be used to modify the contract specification, e.g. by adding, preferably automatically adding descriptive information relating to the recognized object or product to the contract specification. Hereby, said algorithm may process the portion of video content after it was recorded and/or provided but may also operate “real-time” during the recording and/or providing, whereby the proposed editing may preferably be displayed as an overlay on the screen of the first device while the first device is displaying the video content as it is available to the first device, preferably as it is captured by the camera of the first device. Such an embodiment with an overlay may or may not be combined with an embodiment with face recognition, and may preferably relate to augmented reality, virtual reality or mixed reality as known to the skilled person. For instance, an embodiment with said overlay may be particularly advantageous where the first device concerns an optical head-mounted display, whereby partial transparency of the optical display may reduce or even remove the need for the first device to display the video content as it is captured, allowing the first user to focus on the information displayed on the overlay. Regardless of the nature of the first device, the overlay may comprise one or more label and/or identifications of one or more objects, products or persons recognized, whereby said one or more label and/or identification may be displayed in real-time next to the objects, products or persons, and whereby preferably the eventual portion of video content stored as part of the video contract comprises said overlay, either “hard-coded” or as a separate video layer of which the visibility may be controlled separate from that of the data as captured by the camera. Such embodiments advantageously utilize the abundance of contract-related information comprised in the portion of video content, offering significant advantage over state of the art methods for composing agreements. This leads to faster composition of the contract, and overall to a more complete documentation of the video contract.

In one embodiment, said video contract signing invitation comprises an expiry time for limiting a term during which said video contract may be signed. The presence of an expiry time provides the users with more control over the composing and the entire process of managing their video contracts. This is particularly advantageous where the invention provides means for allowing the users access to video contracts that are only partially completed, e.g. with one signature received at the server but the other signature still pending.

In a preferred embodiment, said method comprises the further step of receiving, preferably by said server, a modification of said portion of video content and/or of said contract specification from one of said first and said second user; and wherein said modification gives rise to sending, preferably by said server, a video contract signing invitation associated with said modification to the device belonging to the other of said first and second user, said sending being based on said identification of said other of said first and second user; said video contract signing invitation associated with said modification preferably comprising a modified expiry time for limiting a term during which said video contract may be signed. This has the advantage that the video contract may be modified one or more times by at least one user and preferably by both users before being signed. Again, this is particularly advantageous where the invention provides for means for allowing the users access to video contracts that are only partially completed, e.g. with one signature received at the server but the other signature still pending.

In a preferred embodiment, said step of composing said video contract comprises the receiving by said first device, of an editing of said portion of video content and/or a modification of said contract specification from one of said first and said second user; wherein said editing preferably relates to a trimming and/or slicing and/or splicing of one or more draft portions of video content and/or the composing of an overlay associated with said portion of video content, and wherein said modification of said contract specification may relate to the inclusion of one or more selected and/or edited frames of said portion of video content to said contract specification. Such an embodiment advantageously uses the processing capabilities of state of the art devices such as smartphones, capable of performing fast and reliable video editing. In one embodiment, said editing relates to a trimming and/or slicing and/or splicing of one or more draft portions of video content, providing the users with the benefit of providing the portion of video content in several separate draft portions. This is more user-friendly since it allows, e.g., to record draft portions again in case of mistakes, rather than being forced to do the single take again from the start. Moreover, in a preferred embodiment whereby a template is provided for guiding said composing of said video contract, the template may advantageously provide separate steps for providing and/or recording each separate draft portion of video content, leading to a more controlled composing of the video contract, with an easier flow for the user. In an embodiment with an overlay, the overlay may be added to the portion of video content after it was provided, preferably recorded, but may in some embodiments be composed “real-time” during the recording. Such an embodiment with an overlay may or may not be combined with an embodiment with face, object and/or product recognition. Such an overlay may for instance comprise one or more label and/or identifications of one or more objects, products or persons as recognized by the users and/or one of the algorithms, whereby said one or more label and/or identification may be displayed next to the objects, products or persons, and whereby preferably the eventual portion of video content stored as part of the video contract comprises said overlay, either “hard-coded” or as a separate video layer of which the visibility may be controlled separate from that of the data as captured by the camera. Such embodiments advantageously combine the information provided by users, preferably human users, with the information provided by algorithms. In an embodiment with inclusion of one or more selected and/or edited frames, frames may be edited by some image editing functionality, allowing a user e.g. to draw lines on or to type text over one or more still images (frames) or a short sequence comprising multiple frames. This may enhance user interaction and may expedite the video contract composing.

In a preferred embodiment, said sending, preferably by said server, of said video contract signing invitation to said second user implies the receipt of said first electronic signature from the first user; and/or wherein said sending, preferably by said server, of said video contract signing invitation associated with said modification from one of said first and second user to the device belonging to the other of said first and second user implies the receipt of the electronic signature from said one user. Such an embodiment is advantageous because it expedites the composing and singing of the video contract.

In another preferred embodiment, said identification of said second user relates to a contacting means to reach said second user such as a user account stored on said server and/or an e-mail address and/or a phone number; and wherein said video contract signing invitation is delivered via said contacting means for ensuring that said identification of said second user is linked to said contacting means of said second user. Such an embodiment provides the advantage of enhanced reliability and security.

In a related preferred embodiment, wherein said second device is different from said first device, the video contract signing invitation comprises a token; wherein said providing of said second electronic signature by said second user involves providing said token for ensuring that the person providing said second electronic signature is said second user; and wherein the second user preferably provides said second electronic signature via a device different from said second device, preferably said first device. Such an embodiment advantageously links the person having access to the contacting means to the second user, and ensures that the person providing the electronic signature indeed has access to the contacting means. This may be particularly advantageous if the second device has limited user interface means and/or network connection means. In one example, the second device may be a basic mobile telephone lacking smartphone functionality, comprising means to receive said token but not for signing. In another example, the second device may not have mobile data access, may lack an application needed for signing, or the second user may desire to avoid mobile data access, e.g. for avoiding roaming costs. In such a case the second user may prefer to only receive the token on the second device, e.g. via SMS or via e-mail, and may provide the token via the first device. In one embodiment, the token may relate to and/or may be a numeric or alphanumeric code that may be retrieved by the second user from the second device and entered manually on any device as part of the signing of the video contract. In another embodiment the token may relate to and/or may be a hyperlink, preferably a unique hyperlink generated together with said video contract signing invitation, comprising token-related portions, whereby visiting said hyperlink may initiate and/or contribute to the signing of the video contract. In yet another embodiment, the token may relate to and/or may be a one-dimension barcode or a two-dimensional barcode such as a QR code received on the second device. In such an embodiment, the signing of the video contract by the second party may advantageously done by means of a device different from said second device and comprising a camera, whereby the signing involves the scanning of the barcode displayed on the second device by means of said camera. In such an embodiment, the signing of the video contract by the second party may also be done even more advantageously by means of said first device, as this device may in a preferred embodiment comprise a camera for recording video, whereby the signing involves the scanning of the barcode displayed on the second device by means of the camera of the first device.

In an alternative embodiment, said second device is equal to said first device, wherein the video contract signing invitation comprises a token; wherein said providing of said second electronic signature by said second user involves providing said token for ensuring that the person providing said second electronic signature is said second user. This may be advantageous particularly if the second user does not have a second device available for signing, but does have privileged access, e.g. password-based access, to some contacting means such as a user account stored on said server and/or an e-mail address and/or a phone number. The second user may seek such access via the first device to retrieve said token and may subsequently enter the token to initiate and/or contribute to the signing of the video contract. Hereby, the token may relate to any of the embodiments mentioned in this document, and preferably to said numeric or alphanumeric code or said hyperlink comprising token-related portions.

In a preferred embodiment, said step of composing said video contract comprises storing a smart contract on a blockchain-related distributed computing platform, said smart contract comprising at least an identification of said video contract and preferably a reference to at least one electronic wallet of at least one of said first and second user; and wherein a completion of a task relating to said video contract triggers an event defined by said smart contract, preferably triggering at least a payment by means of said electronic wallet. Such an embodiment may advantageously connect one or more tasks comprised in the video contract to one or more events on a blockchain, such as a registration of a task completion or contract compliance, or preferably a payment for said one or more tasks when completed. Hereby, the identification of said video contract may be done by means of a unique identifier of the video contract as generated by e.g. the first device. Another means of identification may relate to a hash generated from part of or the entire portion of video content by means of a one-way cryptographic hash function such as e.g. SHA-256. Since the portion of video content is an essential part of the video contract, using the hash of the portion of video content is an advantageous means for identifying the video contract.

In a preferred embodiment, said video contract and/or said video contract signing invitation comprise an identification of said portion of video content, preferably a machine-generated identification of said portion of video content, such as a hash based on said portion of video content, more preferably a hash generated from part of or the entire portion of video content by means of a one-way cryptographic hash function such as e.g. SHA-256. Preferably, at least the video contract and more preferably also the video contract signing invitation comprise this identification. In one embodiment, both said portion of video content and the identification of said portion of video content are comprised in the video contract. This has the advantage that some derived form of the video contract, such as a print-out or a compressed version that excludes the actual portion of video content, may still comprise a strong link to the original portion of video content. Such a strong link may also be important e.g. for reasons of non-repudiation, where a user questions the validity of a video contract by claiming that the portion of video present on the server has been edited after the user signed the video contract. Such issues may be addressed appropriately by inspecting whether the original hash present in the video contract as signed and/or as present in the video contract signing invitation still matches the hash of the portion of video content as claimed. Such an embodiment may be advantageously combined with an embodiment wherein a part of the video contract, for instance at least the hash of the portion of video content, is stored on a blockchain, preferably a private blockchain.

In a preferred embodiment, a part of the video contract, preferably at least the hash of the portion of video content, is stored on a blockchain, preferably a private blockchain. Hereby, using the blockchain as ledger may be advantageous to realize non-repudiation with respect to the details of the video contract.

In a preferred embodiment, said method comprises the additional steps of
opening, by said first user, a third-party app on said first device, said third-party app comprising an API-related interface for connecting to said server;
sending an API-related call by said third-party app to said server via said API-related interface for initiating said electronically signing of said video contract;

wherein said additional steps precede the further steps of said method, and wherein actions of at least said first user (1) involved in the execution of said method are preferably mediated by said third-party app based on further API-related calls. Such an embodiment may be advantageous due to its increased modularity. Rather than relying on a single application for initiating the composing the video contract, a third-party app may be used as “front-end”. This may be particularly advantageous, e.g., in cases where the front-end is an application relating to social networking and/or messaging. In such a case, said identification of said first user and said second user involved in the composition of the video contract may be provided in the form of contact information via or by the third-party app. In such an embodiment the API-related call may comprise said contact information and/or said step of composing may comprise importing said contact information from the third-party app into the video contract. In a related further embodiment, actions of at least said first user involved in the execution of said method are mediated by said third-party app based on further API-related calls; wherein said API-related interface relates to an SDK and wherein at least one of said API-related call and said further API-related calls relate to a RESTful API. This further enhances the modularity of the invention. In a further related embodiment, interaction between said third-party application and said server is mediated by an SDK, said SDK preferably comprising said API-related interface. This also enhances the modularity of the invention.

In a preferred embodiment, whereby at least the first user carries out at least the steps of composing the video contract and uploading the video contract, a user account is provided by said server for providing said user with access to one or more uploaded video contracts, preferably all video contracts that are currently valid and in which the user is party to the video contract. In a related embodiment, any user may provide a third party different from said first and second user with partial or full access to one of the video contracts on the server. This may be advantageous e.g. where a user wants to provide a third party with proof that a certain video contract exists and/or with the details of a video contract under discussion.

In yet another embodiment, said step of composing said video contract relates to the use of a template present on said server and/or a template present on the device of the user. Said template relates to the composition of the video according to a step-by-step process or “wizard”, whereby different elements of the video contract are requested to the user(s) in a sequential manner, preferably whereby different separate sub-portions of the portion of video content are provided, preferably recorded, independently and are subsequently spliced/stitched to obtain the final portion of video content. This is advantageous since it enhances user experience. In one embodiment, the template may, in a first phase, request the first user to identify himself e.g. by means of text input and/or by means of a subportion of video content wherein the first user is present in the subportion and/or is filmed, to then repeat the process for the second user and any further users. In a next phase, the template may request to provide details regarding a task and/or object to which the video contract relates. Also these details may be entered e.g. via text input and/or by means of a subportion of video content provided, preferably recorded, for this purpose.

In another preferred embodiment, the invention comprises means for being used “in-app”, i.e. means such as an application programming interface (API) and/or a plug-in are provided for allowing interaction of said server with a third party application, such as a messaging application or a sales platform. In a preferred embodiment, means are provided for allowing an API-related call from the third-party application running on the first device to initiate the execution of the method steps according to the present invention. This may or may not relate to an embodiment wherein the first device comprises a third-party app comprising an API-related interface for connecting to said server, and wherein the initiating of said electronically signing of said video contract comprises sending an API-related call by said third-party app to said server via said API-related interface.

In another preferred embodiment, the second user relates to an automated signing authority. In such an embodiment, the second user is not a physical person (human) yet may relate to an automated signing authority, which may for instance relate to a TSA (timestamp authority) or a CA (certificate authority). In such a case, the signed video contract obtained by the present invention may relate to said video-based proof. Hereby, the first user is the only physical person participating in the video contract, and the other party is merely involved in order to “certify” the video-based proof that was generated by the first user, resulting in a singed video contract signed by two parties.

According to a further aspect, which is not intended to limit the invention's scope in any way, the invention relates to following points 1-22.
1. Method for electronically signing a video contract between a first user (1) having a first device (10) and a second user (2) having a second device (20) based on a portion of video content; said second user (2) being different from said first user (1); said portion of video content providing information relating to said video contract; said first device comprising a camera (12) for recording video, a screen (11) and connection means; said second device comprising a screen (21) and connection means; the method comprising the steps of:
   recording (51), by said first user (1), said portion of video content, by means of said first device (10);
   composing (52), on said first device (1), a video contract comprising said portion of video content and a contract specification (3); said contract specification (3) comprising at least an identification of said first user (1) and said second user (2);
the method comprising the further steps of:
   uploading (52), from said first device (10), said video contract including said portion of video content to a server;
   sending (52), preferably by said server, a video contract signing invitation to said second device (20), said sending based on said identification of said second user (2);
   receiving (53), by the server, a first electronic signature from the first user (1);
   receiving (53), by the server, a second electronic signature from the second user (2).
2. Method according to point 1, wherein said sending of said video contract signing invitation to said second device (20) is performed by said server; and wherein said sending of said video contract signing invitation preferably takes place after said uploading (52) has been completed.
3. Method according to point 1, wherein said sending of said video contract signing invitation to said second device (20) is carried out by said first device (10), preferably without an intervention of said server.
4. Method according to points 1-3, wherein said second user is present within line-of-sight of the second user at least during the step of composing said video contract and preferably also during the recording of said portion of video and/or during the uploading of said video contract, whereby a distance between said first user and said second user is preferably smaller than 20 m, more preferably smaller than 10 m, most preferably smaller than 2 m.
5. Method according to points 1-4, wherein said first device comprises means for attributing a location stamp to video content; wherein said step of recording said portion of video content comprises adding said location stamp to said portion of video content; and wherein said video contract comprises a location indication based on said location stamp.
6. Method according to points 1-5, wherein said first device comprises means for attributing a recording time stamp to video content; wherein said step of recording said portion of video content comprises adding said recording time stamp to said portion of video content; and wherein said video contract signing invitation comprises at least an indication relating to said upload time date and preferably additionally an indication of a time at which said contract signing invitation is sent.
7. Method according to points 1-6, said identification of at least one of said first and second user comprising executing a face recognition algorithm on said portion of video content and/or of a picture taken with said camera of said first device for improving reliability of said identification.
8. Method according to points 1-7, wherein said composing (52) of said video contract comprises executing an object recognition algorithm and/or a product recognition algorithm on said portion of video content, wherein an output of said object recognition algorithm and/or said product algorithm is used for editing said portion of video content and/or modifying said contract specification.
9. Method according to points 1-8, wherein said video contract signing invitation comprises an expiry time for limiting a term during which said video contract may be signed.
10. Method according to points 1-9, wherein said method comprises the further step of receiving, preferably by said server, a modification of said portion of video content and/or of said contract specification from one of said first and said second user; and wherein said modification gives rise to sending, preferably by said server, a video contract signing invitation associated with said modification to the device belonging to the other of said first and second user, said sending being based on said identification of said other of said first and second user; said video contract signing invitation associated with said modification preferably comprising a modified expiry time for limiting a term during which said video contract may be signed.
11. Method according to points 1-10, wherein said step of composing said video contract comprises the receiving by said first device, of an editing of said portion of video content and/or a modification of said contract specification from one of said first and said second user; wherein said editing preferably relates to a trimming and/or slicing and/or splicing of one or more draft portions of video content and/or the composing of an overlay associated with said portion of video content, and wherein said modification of said contract specification may relate to the inclusion of one or more selected and/or edited frames of said portion of video content to said contract specification.
12. Method according to points 1-11, wherein said sending, preferably by said server, of said video contract signing invitation to said second user implies the receipt of said first electronic signature from the first user; and/or wherein said sending, preferably by said server, of said video contract signing invitation associated with said modification from one of said first and second user to the device belonging to the other of said first and second user implies the receipt of the electronic signature from said one user.
13. Method according to points 1-12; wherein said identification of said second user relates to a contacting means to reach said second user such as a user account stored on said server and/or an e-mail address and/or a phone number; and wherein said video contract signing invitation is delivered via said contacting means for ensuring that said identification of said second user is linked to said contacting means of said second user.
14. Method according to point 13, wherein said second device is different from said first device; wherein the video contract signing invitation comprises a token; wherein said providing of said second electronic signature by said second user involves providing said token for ensuring that the person providing said second electronic signature is said second user; and wherein the second user provides said second electronic signature via a device different from said second device, preferably said first device.
15. Method according to point 13, wherein said second device is equal to said first device; wherein the video contract signing invitation comprises a token; wherein said providing of said second electronic signature by said second user involves providing said token for ensuring that the person providing said second electronic signature is said second user.
16. Method according to points 1-15, wherein said step of composing said video contract comprises storing a smart contract on a blockchain-related distributed computing platform, said smart contract comprising at least an identification of said video contract and preferably a reference to at least one electronic wallet of at least one of said first and second user; and wherein a completion of a task relating to said video contract triggers an event defined by said smart contract, preferably triggering at least a payment by means of said electronic wallet.
17. Method according to points 1-16, wherein said video contract and/or said video contract signing invitation comprise a machine-generated identification of said portion of video content, preferably a hash based on said portion of video content.
18. Method according to points 1-17, wherein at least a part of said video contract is stored in a blockchain, preferably a private blockchain.
19. System for electronically signing a video contract between a first user and a second user based on a portion of video content; said second user being different from said first user; said portion of video content providing information relating to said video contract; said system comprising
   a first device belonging to said first user, said first device comprising a camera for recording video, a screen and connection means;
   a second device belonging to said second user, said second device comprising a screen and connection means;
   a server,
wherein said first device is configured for executing the steps of:
   recording, upon request of at least one of said first and said second user, preferably said first user, said portion of video content;
   composing a video contract comprising said portion of video content and a contract specification; said composing comprising receiving a contract specification from at least one of said first and said second user; said contract specification comprising at least an identification of said first user and said second user;
   uploading, upon request of at least one of said first and said second user, preferably said second user, said video contract including said portion of video content to said server;
wherein said server is configured for executing the steps of:
   receiving said video contract including said portion of video content from said first device;
   receiving a first electronic signature from the first user via said first or said second device;
   receiving a second electronic signature from the first user via said first or said second device;
wherein said second device is configured for executing the steps of:
   receiving a video contract signing invitation, preferably from said server;
wherein at least one of said first and said second device, preferably said first device, is configured for receiving said first electronic signature from the first user and sending said first electronic signature from the first user to said server; wherein at least one of said first and said second device, preferably said second device, is configured for receiving said second signature from said second user and for sending said second electronic signature from the second user to said server; and wherein at least one of said first device and said server, preferably said server, is configured for sending said video contract signing invitation to said second device, said sending based on said identification of said second user.
20. Use of the method according to points 1-18 in the system according to point 19.
21. Computer program product for carrying out a computer-implemented method for electronically signing a video contract between a first user having a first device and a second user having a second device based on a portion of video content; which computer program product comprises at least one readable medium in which computer-readable program code portions are saved, which program code portions comprise instructions for carrying out said computer-implemented method on said first device; said computer-implemented method comprising the steps of:
   recording, upon request of one of said first and said second user, said portion of video content;
   composing a video contract comprising said portion of video content and a contract specification; said composing comprising receiving a contract specification from at least one of said first and said second user; said contract specification comprising at least an identification of said first user and said second user;
   uploading, upon request of at least one of said first and said second user, said video contract including said portion of video content to a server;
   receiving a first electronic signature from the first user and/or a second electronic signature from the second user and sending each of the received electronic signatures to said server;
wherein said server is configured for executing the steps of:
   receiving said video contract including said portion of video content from said first device;
   receiving said first electronic signature from the first user;
   receiving said second electronic signature from the first user;
wherein said second device is configured for executing the steps of:
   receiving a video contract signing invitation from said server;
   preferably, receiving a first electronic signature from the first user and/or a second electronic signature from the second user and sending each of the received electronic signatures to said server;
and wherein at least one of the computer-implemented method for execution on said first device and said steps which the server is configured to execute, preferably said steps which the server is configured to execute, comprise the sending of said video contract signing invitation to said second device, said sending based on said identification of said second user.
22. A video contract composed and signed by means of a method according to points 1-18, said method preferably executed on a system according to point 19.

According to yet another aspect, which is not intended to limit the invention's scope in any way, the invention relates to following items 1-8.
1. Method for establishing an electronic video-based proof by a first user having a first device based on a portion of video content; said portion of video content providing information relating to said video-based proof; said first device preferably comprising a camera for recording video, a screen and connection means; the method comprising the steps of:
   providing said portion of video content by said first user to said first device, preferably by recording, by said first user, said portion of video content by means of said first device;
   composing, on said first device, said video-based proof comprising said portion of video content and a proof specification; said proof specification comprising at least an identification of said first user;
the method comprising the further steps of:
   uploading, from said first device, said video-based proof including said portion of video content to a server;
   preferably, receiving, by the server, a first electronic signature from the first user.
2. Method according to item 1, wherein said step of said providing of said video content comprises recording, by said first user, said portion of video content by means of said first device, preferably wherein said providing of said video content consists of recording, by said first user, said portion of video content by means of said first device.
3. Method according to item 2, wherein said first device comprises a camera, and wherein said recording is performed by means of said first device.
4. Method according to items 1-3, wherein said first device comprises means for attributing a location stamp to video content; wherein said step of recording said portion of video content comprises adding said location stamp to said portion of video content; and wherein said video-based proof comprises a location indication based on said location stamp.
5. Method according to items 1-4, wherein said first device comprises means for attributing a recording time stamp to video content; wherein said step of recording said portion of video content comprises adding said recording time stamp to said portion of video content; and wherein said video-based proof comprises at least an indication relating to said recording time stamp and preferably additionally an indication of a time at which said video-based proof is uploaded and/or preferably signed.
6. Method according to items 1-5, wherein said step of composing said video-based proof comprises storing a smart contract on a blockchain-related distributed computing platform, said smart contract comprising at least an identification of said video-based proof and preferably a reference to at least one electronic wallet of said first user; and wherein a completion of a task relating to said video contract triggers an event defined by said smart contract, preferably triggering at least a payment by means of said electronic wallet.
7. Method according to items 1-6, wherein said video-based proof comprises a machine-generated identification of said portion of video content, preferably a hash based on said portion of video content.
8. Method according to items 1-7, wherein at least a part of said video-based proof is stored in a blockchain, preferably a private blockchain.

It is further to be noted that the composing and signing of video contracts may preferably relate to said establishing of video-based proof in that a video contract may preferably be used as a video-based proof, and this preferably regardless of whether the second user interacts with the server or not. In this regard, any method or system allowing to sign video contracts may preferably be suitable for and/or adapted to establishing video-based proof, since the steps executed by the first user in signing a video contract preferably imply that the first user is establishing a video-based proof according to the present invention.

The invention is further described by the following non-limiting examples which further illustrate the invention, and are not intended to, nor should they be interpreted to, limit the scope of the invention.

### EXAMPLES

### Example 1: Example Embodiment of a Method According to the Present Invention

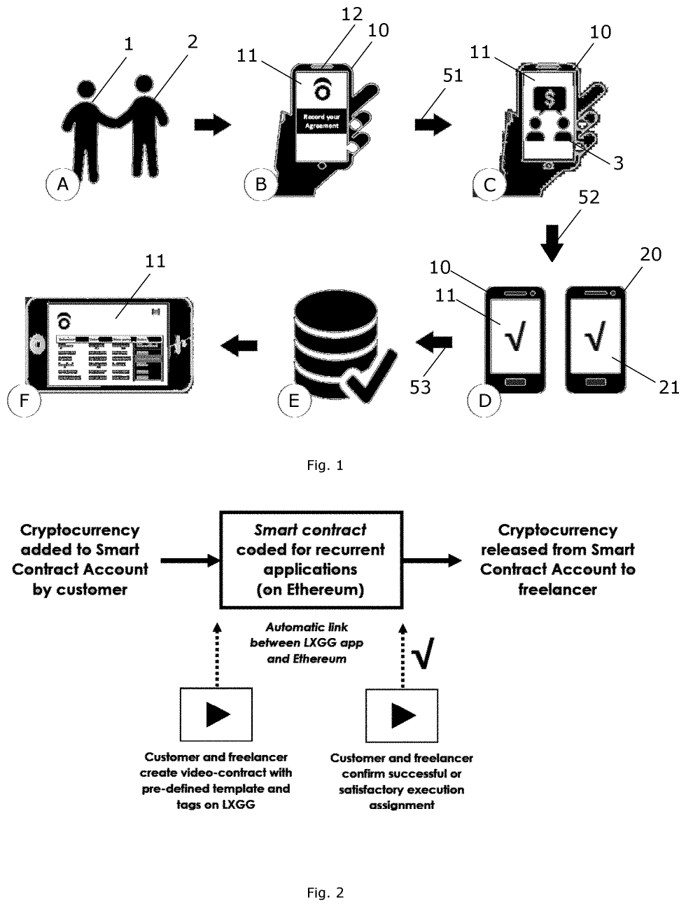

FIG. 1 shows an example embodiment of the method of the present invention. The example method is illustrated by a flow of six steps A to F and according respective pictorial representations. In step A, two registered users want to make an agreement. In step B, one of the users opens the app and selects recording, selecting a message such as “Record a contract” or “Record your agreement”. Moving from step C to step D, a (selfie) video is recorded in which both users describe their agreement (they can also include/show any relevant attributes). A specification is added to the video contract in a separate step C. In step D, once the video contract is recorded and the specification is added, the video contract is uploaded to the server, and both users have to confirm the agreement (in-app). In step E, upon confirmation by both users, the video agreement is stored in database (not locally), i.e. on a remote server. In an optional step F, one of the users may use a graphical user interface, preferably in-app, to easily consult, watch and manage his or her video agreements.

As such, the example method relating to steps A to E provides an embodiment of a method for electronically signing a video contract between a first user (1) having a first device (10) and a second user (2) having a second device (20) based on a portion of video content; said second user (2) being different from said first user (1); said portion of video content providing information relating to said video contract; said first device comprising a camera (12) for recording video, a screen (11) and connection means; said second device comprising a screen (21) and connection means; the method comprising the steps of:
recording (51), by said first user (1), said portion of video content, by means of said first device (10);
composing (52), on said first device (1), a video contract comprising said portion of video content and a contract specification (3); said contract specification (3) comprising at least an identification of said first user (1) and said second user (2);

the method comprising the further steps of:
uploading (52), from said first device (10), said video contract including said portion of video content to a server;
sending (52), preferably by said server, a video contract signing invitation to said second device (20), said sending based on said identification of said second user (2);
receiving (53), by the server, a first electronic signature from the first user (1);
receiving (53), by the server, a second electronic signature from the second user (2).

### Example 2: Example Embodiment with Smart Video Contract

FIG. 2 shows an example embodiment relating to smart video contracts, whereby the first user, a freelancer, offers a service to a second user, a customer, and the video contract specifies the details of the service and the price that is to be paid by the customer to the freelancer once the assignment relating to the service is completed. Hereby, the invention relates to the use of an app, here called LXGG app, which allows the users to compose the video contract by means of pre-defined template and provides the interface with a blockchain-related distributed computing platform. Particularly, in this embodiment, said step of composing said video contract comprises storing a smart contract on Ethereum, said smart contract comprising an identification of said video contract and a reference to the electronic wallet of the customer. Hereby, the smart contract is configured according to the pricing specified by the video contract. The completion of the assignment relating to said video contract, as confirmed by the customer and the freelancer, triggers the payment of the amount specified in the video contract by means of the smart contract, whereby the agreed amount of cryptocurrency, i.e. Ethers, is transferred from the electronic wallet of the customer to the freelancer, preferably to the electronic wallet of the freelancer.

### Example 3: Flow Diagram of Example Method for Creation of Video Contract

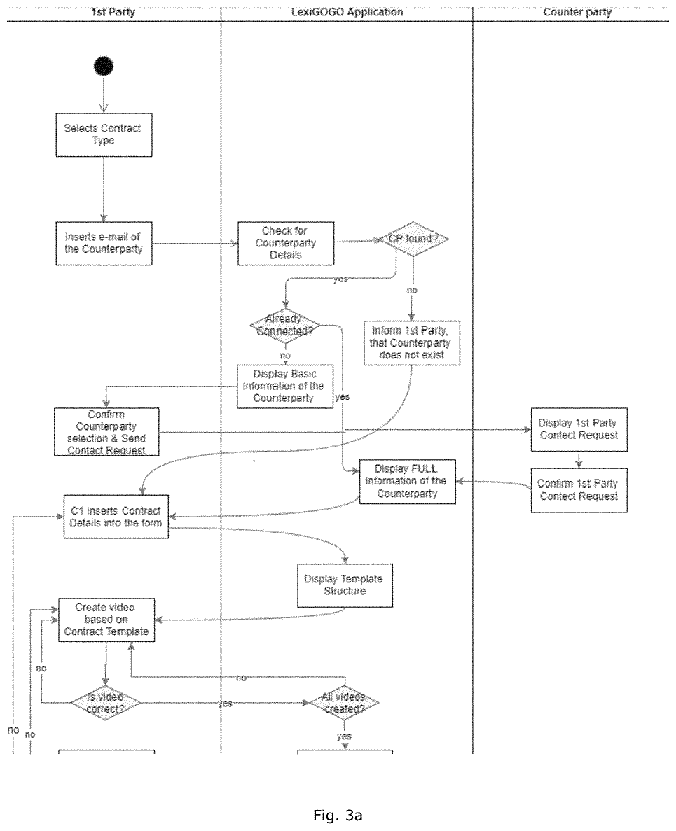

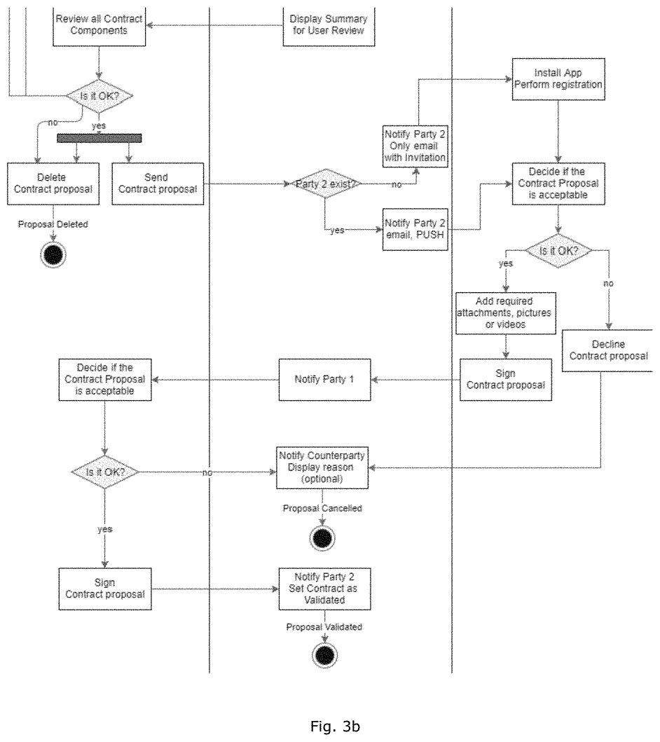

FIGS. 3a and 3b show a flow diagram of an example method for creation of a video contract.

### Example 4: Flow Diagram Relating to States of Example Video Contract

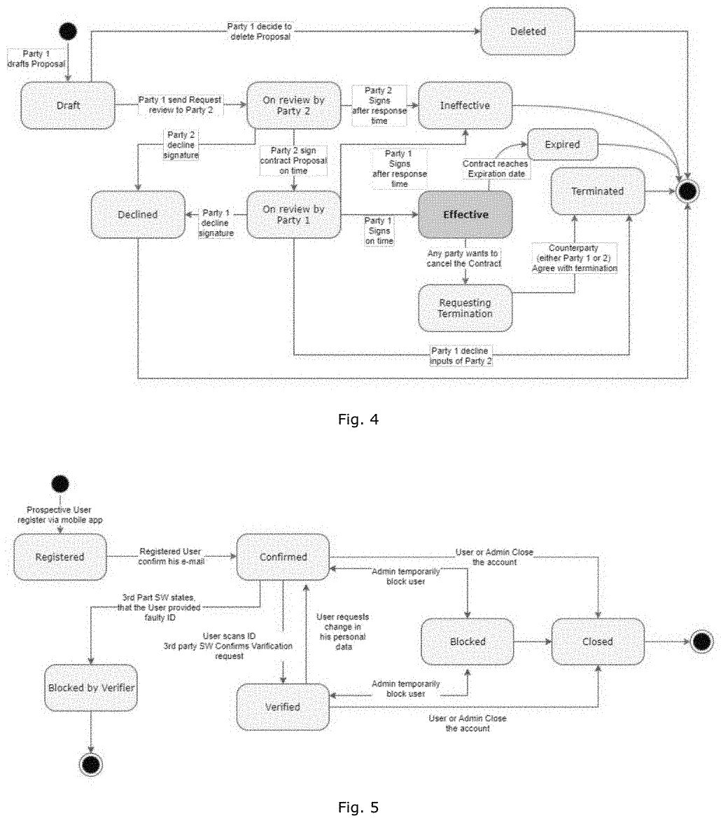

FIG. 4 shows a flow diagram relating to states of an example video contract according to the present invention.

### Example 5: Flow Diagram Relating to States of Example User Account

FIG. 5 shows a flow diagram relating to states of an example user account.

### Example 6: Example SaaS Architecture

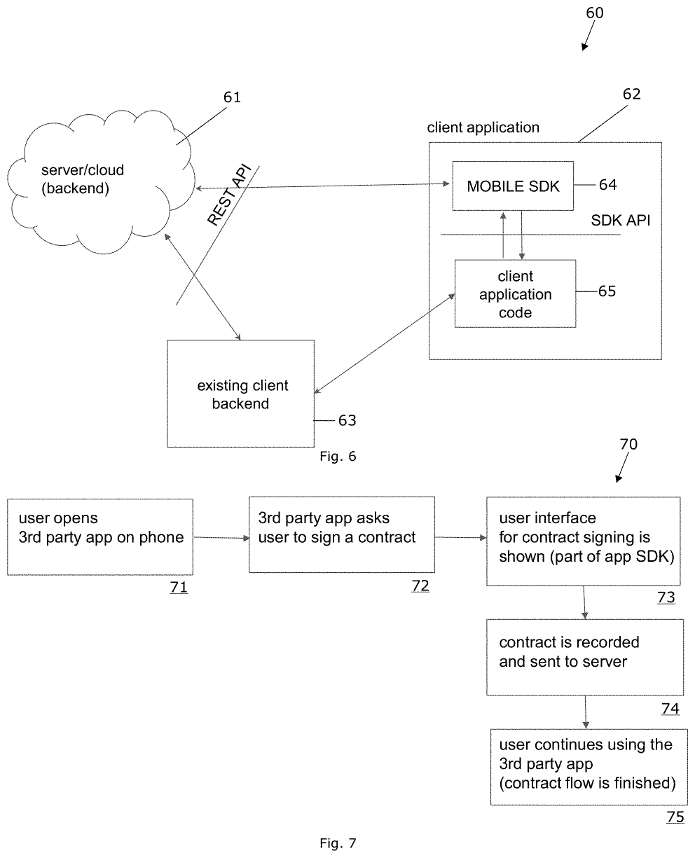

FIG. 6 shows an example software as a service (SaaS) architecture 60. This corresponds to an example embodiment of the invention with integration with a third-party app. Hereby, the signing of video contracts is provided as a service to the third party, and relates to a SaaS configuration. This is to be distinguished from an embodiment wherein the invention works solely with said app and not with a third-party app. In the example, in view of third-party app integration, the following steps are executed before the actual initiation of composing and signing the video contract:
opening, by said first user, a third-party app on said first device, said third-party app comprising an API-related interface for connecting to said server;
sending an API-related call by said third-party app to said server via said API-related interface for initiating said electronically signing of said video contract;

wherein actions of at least said first user involved in composing the video contract and having it signed are mediated by said third-party app based on further API-related calls.

The SAAS architecture 60 shown in FIG. 6 comprises a server/cloud 61, also referred to as cloud or server in this document, as well as a client application 62 and the third-party backend 63, also referred to as client backend. Hereby, the third party is also referred to as client. The client application which may be running as an app at least on the device of the first user, i.e. the first device, and preferably also on the device of the second user, i.e. the second device. The client application may for instance relate to a messaging app, and comprises client application code 65 which is developed by the third party. The client application code allows to interact with the client backend. The client application 62 further comprises an API-related interface for connecting to the cloud 61, in this example being a mobile SDK 64. The SDK is provided by the party providing the service of video contracts. The SDK 64 interacts with the cloud 61 according to a REST API with a suitable communication protocol, preferably JSON or OAuth. Furthermore, the cloud 61 and the client backend 63 are preferably configured for interacting according to a REST API with a suitable communication protocol, preferably JSON or OAuth. Preferably at least one of, more preferably both of the SDK 64 and the client backend 63 may query the cloud 61 for contract data, files, streaming and additional services.

For third parties, the advantages provided by any embodiment with integration/interaction with their third party app may relate to price, agility and increased user-friendliness. As the cloud is not to be maintained by them, no additional staff or additional server infrastructure is required from the third party. Such a solution may be agile in that the third party is only required to update the SDK to perform updates relating to video contracts. Finally, as video contracts are aggregated for each user, the user may be able to view all his/her contracts for different companies in one place, leading to enhanced user-friendliness.

### Example 7: Third-Party App Integration Example

FIG. 7 shows an example workflow 70 relating to a set-up with third-party application integration. This preferably relates to the underlying architecture according to the example SaaS architecture of Example 6. In a first step 71, the first user opens the third-party app on the first device, being a smartphone, to initiate the video contract. In the next step 72, the first user is asked to sign a video contract. In the next step 73, a user interface is shown for contract signing, whereby the interface is provided by the SDK comprised in the third-party app. In the following step 74, the contract is recorded and is sent to the server, preferably the server/cloud 61 of Example 6. After that, in a next step 75, the contract flow terminates and the user may continue using the third-party app.

In one embodiment, developers of the third-party app may download the SDK according to an Android or iOS version, to then integrate the SDK in the existing third-party application. Preferably, the SDK automatically handles communication with the server, covers the whole video contract workflow including user interfaces (screens). Moreover, preferably the third party can style/customize each screen and text and add branding if necessary.

Preferably, in a use case according to workflow 70, the user is never forced to leave the third-party application.

### Example 8: Example Information Flows

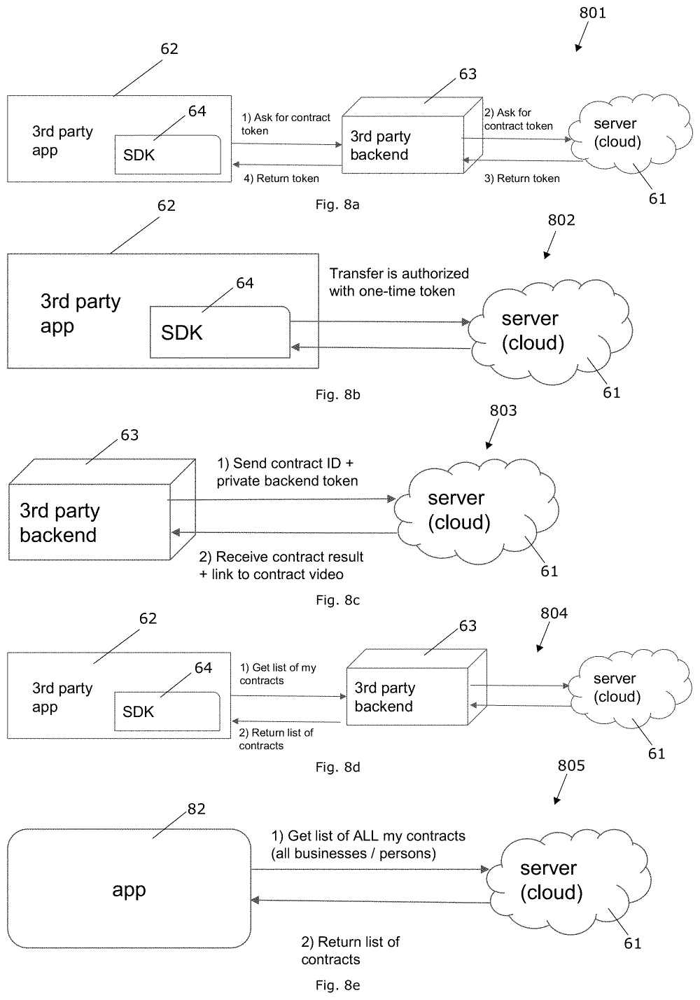

FIGS. 8a-8e show example information flows relating to the invention. These embodiments relate to integration with a third-party app, and preferably relate to the SaaS architecture of Example 6 and/or the third-party app integration of Example 7.

The first example information flow 801 relates to the initiating of a contract. Particularly, this relates to obtaining a unique (one-time) token for a given user of the third-party app from the cloud 61.

The second example information flow 802 relates to the uploading of a video contract. Particularly, this relates to authorizing the video contract by means of the one-time token obtained earlier according to e.g. the first information flow 801.

The third example information flow 803 relates to the verification of a video contract by a third party. Particularly, this relates to sending a contract ID referring to the video contract that is to be verified, together with a private backend token which may, e.g., authenticate the third-party backend 63 with the cloud 61. The response may comprise the contract result as well as a link to the contract video, e.g., a URL.

The fourth example information flow 804 relates to the viewing of video contracts by the first or second user by means of the third-party application. Particularly, this relates to the steps involved in viewing a list of all video contracts of the user.

The fifth example information flow 805 relates to the viewing of video contracts by the first or second user by means of the app provided by the party providing the cloud 61.

Note that this information flow 805 may relate to an embodiment with or without third-party integration, whereby the number of third-party applications may be 1, 2, 3, or any number larger than 3. Hereby, the user may request viewing all contracts, and hence may view video contracts created via the app with different persons and/or different companies/businesses.

### Example 9: Example with Multiple Devices for the First User

This example relates to the signing of a video contract relating to a building, e.g. relating to a construction project. The first user may be the one who commissioned the construction project, whereas the second user may be a contractor. The portion of video content as provided by the first user is recorded by a device different from the first device, particularly a digital video camera, preferably an action camera, mounted on a drone. The drone enables to fly over the construction site during the construction of the building. This enables an overview over the construction site which is much more detailed than any contract on paper would allow. After the action camera has finished recording, the raw material recorded by the action camera is provided to the first device. This may for instance be performed by means of a connection between the action camera and the first device. This direct connection may relate to a wireless connection such as a Bluetooth (peer-to-peer) connection, a Wi-Fi-based connection, a cellular network connection, or a wired connection such as a USB connection involving a cable. In a next step, the first user edits the raw material until he obtains the portion of video content adapted for being used in the video contract.

### Example 10: Example Workflow for the First User

This example illustrates the typical workflow from the point of view of the first user. First, the user opens an app on the first device to initiate the video contract. This comprises entering a title and a photo. In the next step, the user is asked to provide the portion of video content. The choice is given to either indicate a file location on the first device relating to the portion of video content, or to record a new portion of video content. Hereby, the former case may e.g. correspond to Example 9, whereby the portion of video content is the result of an action camera recording which is later edited and then stored on the first device. As soon as the portion of video content is provided, uploading to the server starts. As soon as uploading has started, the first user is asked for further information while the uploading continues. The first user is asked to provide the name and contact details of the second user. In a next step, the second user is contacted by means of e-mail and/or via an in-app notification and is requested to sign the video contract. After signing, the first user is informed by means of e-mail and/or via an in-app notification of the signing by the second user, and is requested to sign too. As soon as the first user has also signed the video contract, the video contract is considered signed.

### Example 11: Example of Establishing Video-Based Proof

In this example, the first user establishes a video-based proof. This video-based proof may or may not be the basis for a signed video contract later on, since the video-based proof may include all elements needed for obtaining a signing video contract, lacking only the identification and signature of the second user. By adding these elements later on, an existing video-based proof may lead to a signed video contract. On the other hand, the first user may establish a video-based proof without aiming to have it signed by a second user later on, or may have a non-human second user, such as a TSA or CA, sign the video contract. wherein said step of said providing of said video content comprises recording, by said first user, said portion of video content by means of said first device, preferably wherein said providing of said video content consists of recording, by said first user, said portion of video content by means of said first device.

The first device comprises a camera, and said recording is performed by means of said first device. Said first device comprises means for attributing a location stamp to video content. Said step of recording said portion of video content comprises adding said location stamp to said portion of video content. Said video-based proof comprises a location indication based on said location stamp.

Furthermore, the first device comprises means for attributing a recording time stamp to video content. Hereby, said step of recording said portion of video content comprises adding said recording time stamp to said portion of video content. Said video-based proof comprises said recording time stamp. At least a part of said video-based proof is stored in a blockchain, preferably a private blockchain.

1. A method for electronically signing a video contract between a first user having a first device and a second user having a second device based on a portion of video content; said second user being different from said first user; said portion of video content providing information relating to said video contract; said first device preferably comprising a camera for recording video, a screen and connection means; said second device comprising a screen and connection means; the method comprising the steps of:
providing said portion of video content by said first user to said first device, preferably by recording, by said first user, said portion of video content by means of said first device;
composing, on said first device, a video contract comprising said portion of video content and a contract specification; said contract specification comprising at least an identification of said first user and said second user;
the method comprising the further steps of:
uploading, from said first device, said video contract including said portion of video content to a server;
sending, preferably by said server, a video contract signing invitation to said second device, said sending based on said identification of said second user;
receiving, by the server, a first electronic signature from the first user; and
receiving, by the server, a second electronic signature from the second user.

2. The method according to claim 1, wherein said step of said providing of said video content comprises recording, by said first user, said portion of video content by means of said first device, preferably wherein said providing of said video content consists of recording, by said first user, said portion of video content by means of said first device.

3. The method according to claim 2, wherein said first device comprises a camera, and wherein said recording is performed by means of said first device.

4. The method according to claim 1, wherein said uploading takes place at least partly during any of said step of providing said portion of video content and said step of said composing, preferably wherein said uploading takes place at least partly during said step of composing.

5. The method according to claim 1, wherein said sending of said video contract signing invitation to said second device is performed by said server; and wherein said sending of said video contract signing invitation preferably takes place after said uploading has been completed.

6. The method according to claim 1, wherein said sending of said video contract signing invitation to said second device is carried out by said first device, preferably without an intervention of said server.

7. The method according to claim 1, wherein said second user is present within line-of-sight of the second user at least during the step of composing said video contract and preferably also during the recording of said portion of video and/or during the uploading of said video contract, whereby a distance between said first user and said second user is preferably smaller than 20 m, more preferably smaller than 10 m, most preferably smaller than 2 m.

8. The method according to claim 1, wherein said first device comprises means for attributing a location stamp to video content; wherein said step of recording said portion of video content comprises adding said location stamp to said portion of video content; and wherein said video contract comprises a location indication based on said location stamp.

9. The method according to claim 1, wherein said first device comprises means for attributing a recording time stamp to video content; wherein said step of recording said portion of video content comprises adding said recording time stamp to said portion of video content; and wherein said video contract signing invitation comprises at least an indication relating to said upload time date and preferably additionally an indication of a time at which said contract signing invitation is sent.

10. The method according to claim 1, said identification of at least one of said first and second user comprising executing a face recognition algorithm on said portion of video content and/or of a picture taken with said camera of said first device for improving reliability of said identification.

11. The method according to claim 1, wherein said composing of said video contract comprises executing an object recognition algorithm and/or a product recognition algorithm on said portion of video content, wherein an output of said object recognition algorithm and/or said product algorithm is used for editing said portion of video content and/or modifying said contract specification.

12. The method according to claim 1, wherein said video contract signing invitation comprises an expiry time for limiting a term during which said video contract may be signed.

13. The method according to claim 1, wherein said method comprises the further step of receiving, preferably by said server, a modification of said portion of video content and/or of said contract specification from one of said first and said second user; and wherein said modification gives rise to sending, preferably by said server, a video contract signing invitation associated with said modification to the device belonging to the other of said first and second user, said sending being based on said identification of said other of said first and second user; said video contract signing invitation associated with said modification preferably comprising a modified expiry time for limiting a term during which said video contract may be signed.

14. The method according to claim 1, wherein said step of composing said video contract comprises the receiving by said first device, of an editing of said portion of video content and/or a modification of said contract specification from one of said first and said second user; wherein said editing preferably relates to a trimming and/or slicing and/or splicing of one or more draft portions of video content and/or the composing of an overlay associated with said portion of video content, and wherein said modification of said contract specification may relate to the inclusion of one or more selected and/or edited frames of said portion of video content to said contract specification.

15. The method according to claim 1, wherein said sending, preferably by said server, of said video contract signing invitation to said second user implies the receipt of said first electronic signature from the first user; and/or wherein said sending, preferably by said server, of said video contract signing invitation associated with said modification from one of said first and second user to the device belonging to the other of said first and second user implies the receipt of the electronic signature from said one user.

16. The method according to claim 1; wherein said identification of said second user relates to a contacting means to reach said second user such as a user account stored on said server and/or an e-mail address and/or a phone number; and wherein said video contract signing invitation is delivered via said contacting means for ensuring that said identification of said second user is linked to said contacting means of said second user.

17. The method according to claim 16, wherein said second device is different from said first device; wherein the video contract signing invitation comprises a token; wherein said providing of said second electronic signature by said second user involves providing said token for ensuring that the person providing said second electronic signature is said second user; and wherein the second user provides said second electronic signature via a device different from said second device, preferably said first device.

18. The method according to claim 17, wherein said second device is equal to said first device; wherein the video contract signing invitation comprises a token; wherein said providing of said second electronic signature by said second user involves providing said token for ensuring that the person providing said second electronic signature is said second user.

19. The method according to claim 1, wherein said step of composing said video contract comprises storing a smart contract on a blockchain-related distributed computing platform, said smart contract comprising at least an identification of said video contract and preferably a reference to at least one electronic wallet of at least one of said first and second user; and wherein a completion of a task relating to said video contract triggers an event defined by said smart contract, preferably triggering at least a payment by means of said electronic wallet.

20. The method according to claim 1, wherein said video contract and/or said video contract signing invitation comprise a machine-generated identification of said portion of video content, preferably a hash based on said portion of video content.

21. The method according to claim 1, wherein at least a part of said video contract is stored in a blockchain, preferably a private blockchain.

22. The method according to claim 1, wherein said method comprises the additional steps of
opening, by said first user, a third-party app on said first device, said third-party app comprising an API-related interface for connecting to said server;
sending an API-related call by said third-party app to said server via said API-related interface for initiating said electronically signing of said video contract;
wherein said additional steps precede the further steps of said method, and wherein actions of at least said first user involved in the execution of said method are preferably mediated by said third-party app based on further API-related calls.

23. The method according to claim 22, wherein actions of at least said first user involved in the execution of said method are mediated by said third-party app based on further API-related calls; wherein said API-related interface relates to an SDK and wherein at least one of said API-related call and said further API-related calls relate to a RESTful API.

24. The method according to claim 22, wherein interaction between said third-party application and said server is mediated by an SDK, said SDK preferably comprising said API-related interface.

25. A system for electronically signing a video contract between a first user and a second user based on a portion of video content; said second user being different from said first user; said portion of video content providing information relating to said video contract; said system comprising
a first device belonging to said first user, said first device comprising a screen and connection means, said first device preferably comprising a camera for recording video, said first device preferably comprising a third-party app, wherein said third-party app preferably comprises an API-related interface for connecting to said server and a backend-related interface for connecting to said third-party server;
a second device belonging to said second user, said second device comprising a screen and connection means;
a server;
preferably, a third-party server;
wherein said first device is configured for executing the steps of:
preferably, letting said first user open said third-party app;
preferably, having said third-party app send an API-related call to said server via said API-related interface for initiating said electronically signing of said video contract,
receiving said portion of video content from said first and/or said second user, preferably via said third-party app, preferably by recording, upon request of at least one of said first and said second user, preferably said first user, said portion of video content;
composing, preferably via said third-party app, a video contract comprising said portion of video content and a contract specification; said composing comprising receiving a contract specification from at least one of said first and said second user; said contract specification comprising at least an identification of said first user and said second user;
uploading, preferably via said third-party app, upon request of at least one of said first and said second user, preferably said second user, said video contract including said portion of video content to said server;
wherein said server is configured for executing the steps of:
receiving said video contract including said portion of video content from said first device;
receiving a first electronic signature from the first user via said first or said second device;
receiving a second electronic signature from the first user via said first or said second device;
wherein said second device is configured for executing the steps of:
receiving a video contract signing invitation, preferably from said server;
wherein at least one of said first and said second device, preferably said first device, is configured for receiving said first electronic signature from the first user and sending said first electronic signature from the first user to said server; wherein at least one of said first and said second device, preferably said second device, is configured for receiving said second signature from said second user and for sending said second electronic signature from the second user to said server; and wherein at least one of said first device and said server, preferably said server, is configured for sending said video contract signing invitation to said second device, said sending based on said identification of said second user.

26. (canceled)

27. A computer program product for carrying out a computer-implemented method for electronically signing a video contract between a first user having a first device and a second user having a second device based on a portion of video content; which computer program product comprises at least one readable medium in which computer-readable program code portions are saved, which program code portions comprise instructions for carrying out said computer-implemented method on said first device; said computer-implemented method comprising the steps of:
receiving said portion of video content from said first and/or said second user, preferably by recording, upon request of one of said first and said second user, said portion of video content;
composing a video contract comprising said portion of video content and a contract specification; said composing comprising receiving a contract specification from at least one of said first and said second user; said contract specification comprising at least an identification of said first user and said second user;
uploading, upon request of at least one of said first and said second user, said video contract including said portion of video content to a server;
receiving a first electronic signature from the first user and/or a second electronic signature from the second user and sending each of the received electronic signatures to said server;
wherein said server is configured for executing the steps of:
receiving said video contract including said portion of video content from said first device;
receiving said first electronic signature from the first user;
receiving said second electronic signature from the first user;
wherein said second device is configured for executing the steps of:
receiving a video contract signing invitation from said server;
preferably, receiving a first electronic signature from the first user and/or a second electronic signature from the second user and sending each of the received electronic signatures to said server;
and wherein at least one of the computer-implemented method for execution on said first device and said steps which the server is configured to execute, preferably said steps which the server is configured to execute, comprise the sending of said video contract signing invitation to said second device, said sending based on said identification of said second user.

28. A video contract composed and signed by means of the method according to claim 1.
